(19) United States
(12) Patent Application Publication
(10) Pub. No.: US 2026/0279000 A1
(43) Pub. Date: Sep. 17, 2026

(54) Precision-Quantized Sparse Representation Recognition Method for Disassembled Parts of Waste Electrical Appliance

(71) Applicant: Beijing University of Technology, Beijing (CN)

(72) Inventors: Honggui Han, Beijing (CN); Yiming Liu, Beijing (CN); Fangyu Li, Beijing (CN); Yongping Du, Beijing (CN)

(21) Appl. No.: 19/310,663

(22) Filed: Aug. 26, 2025

(30) Foreign Application Priority Data
Mar. 15, 2025 (CN) 202510309953.4

(51) Int. Cl. G06V 10/40; G06V 10/72; G06V 10/764; G06V 10/774; G06V 10/776; G06V 10/82; G06V 10/94; G06V 20/70

(52) U.S. Cl. CPC G06V 10/513; G06V 10/72; G06V 10/764; G06V 10/774; G06V 10/776; G06V 10/82; G06V 10/95; G06V 20/70

(57) ABSTRACT

A method for recognizing disassembled components of waste electrical appliances based on sparse representation with precision quantization is disclosed. The method addresses instability in decision-related features and weight allocation during the quantization process of deep learning models. A ConvNeXt-Tiny network is used to extract deep features from images of disassembled components. A quantization error loss function is applied to optimize the training of weights, while a distribution loss function freezes unstable bit-width parameters during training. This approach enables accurate classification of disassembled components and improves overall recognition accuracy. In practical disassembly scenarios, the method effectively mitigates quantization-related instability and achieves efficient classification and identification of component types, providing technical support for the recycling of waste electrical appliances.

### TECHNOLOGY AREA

A recognition method for disassembled components of waste electrical appliances is proposed based on precision-quantized sparse representation. The method collects image data of disassembled components and constructs a recognition model using the ConvNeXt-Tiny network. Training is performed using a precision-quantized sparse representation approach to enable efficient classification. Instability in decision features and weight allocation caused by quantization is effectively addressed. Reliable technical support is provided for resource utilization and environmental protection in the recycling of waste electrical appliances.

### TECHNOLOGY BACKGROUND

The rapid advancement of technology and the frequent replacement of household appliances have significantly increased the rate of appliance turnover. Disassembled components of waste electrical appliances contain large amounts of recyclable materials such as metals and plastics, along with hazardous substances including lead, mercury, and cadmium. Proper classification and disassembly of waste appliances are essential for promoting resource recycling. However, the diversity and complexity of appliance structures make manual sorting time-consuming, labor-intensive, and prone to low accuracy. An automated and precise method for identifying waste appliance categories is urgently needed.

Full-precision deep neural networks have been widely applied in object recognition tasks and achieve high accuracy in visual domains. In the context of waste appliance recognition, such networks outperform shallow models in classification performance. However, they require significant computational resources, lack real-time efficiency, and present deployment challenges. Quantization methods can reduce model complexity and enhance inference speed. In practical disassembly scenarios, quantization often introduces instability in decision features and weight distribution, which undermines recognition effectiveness.

A recognition method based on precision-quantized sparse representation is proposed to achieve intelligent and efficient identification of disassembled components of waste electrical appliances. A quantization error loss function is designed to optimize weight updates during quantization training. A distribution loss function is also employed to freeze unstable bit-widths during training, enabling accurate classification. The method addresses instability caused by quantization and improves recognition reliability in real-world disassembly applications.

### SUMMARY OF THE INVENTION

a precision-quantized sparse representation recognition method for disassembled parts of waste electrical appliance, is implemented via the following device structure:
an integrated edge computing recognition terminal device includes an industrial grade high resolution camera, a gigabit ethernet port, a visual pre-processing module, a neural processing unit, a capacitive touchscreen, and a data server: the industrial grade high resolution camera is used to capture images of disassembled parts on the waste electrical appliance disassembly line; the gigabit ethernet port is used to transmit the captured images to the subsequent computation unit in real time; the visual pre-processing module is used to adjust the brightness, contrast, and sharpness of the captured images; the neural network processor is used to perform image recognition; the capacitive touch screen is used to display the recognition results of the disassembled parts; the data server is used to store the recognition results;
the workflow of the integrated edge computing recognition terminal device is as follows: first, the industrial grade high resolution camera captures and transmits images of the disassembled parts at the edge computing terminal via an ethernet data interface; second, the visual pre-processing module enhances the quality of the captured images, and the neural processing unit outputs the image recognition results; third, the category labels of the disassembled parts are displayed on the capacitive touch screen, and the category labels of the disassembled parts are transformed into a structured form and stored in the data server, with the specific recognition method as follows:
(1) get a dataset containing images of disassembled parts of waste electrical appliance categorized into 12 types: including circuit boards, wires, aluminum, compressors, condensers, transformers, copper tubes, external motors, drains, flame-retardant, waste clutter, and internal fans; normalize the pixel values of each image in the disassembled parts of waste electrical appliance dataset to the range [0,1], to meet recognition model requirements;
the normalized image dataset of disassembled parts of waste electrical appliance is divided into a training set and a test set, with the training set being Xₛ and the test set being \hat{X}ₛ; s is the total number of images with disassembled parts of waste electrical appliance; the total number of \hat{X}ₛ images is 30% of s; the disassembled parts of waste electrical appliances in both \hat{X}ₛ and Xₛ consist of 12 categories;
(2) construct the disassembled parts recognition model of waste electrical appliances with ConvNeXt-Tiny: the model consists of five parts, the first part conv1 consists of a 1×1 convolutional layer, a batch normalization layer, and a GeLU activation function layer, with a channel count of 96; the second part conv2 includes two inverted bottleneck modules, each consisting of a 1×1 depthwise separable convolutional layer, a GeLU activation function layer, and a 1×1 convolutional layer, with a channel count of 96; the third part conv3 contains two inverted bottleneck modules, each consisting of a 1×1 depthwise separable convolutional layer, a GeLU activation function layer, and a 1×1 convolutional layer, with a channel count of 192; the fourth part conv4 is composed of two inverted bottleneck modules, each consisting of a 1×1 depthwise separable convolutional layer, a GeLU activation function layer, and a 1×1 convolutional layer, with a channel count of 384; the fifth part conv5 incorporates two inverted bottleneck modules, each consisting of a 1×1 depthwise separable convolutional layer, a GeLU activation function layer, and a 1×1 convolutional layer, with a channel count of 768; Xₛ is the input for the disassembled parts recognition model of waste electrical appliance with ConvNeXt-T; define F_{θ} (Xₛ; θₜ) as the feature extractor of the disassembled parts recognition model of waste electrical appliance; t is the number of training epochs; θₜ is the learnable parameters of F_{θ} (Xₛ; θₜ) with a parameter matrix size of 512×28×28; G_{ω} (F; ωₜ) is the output of the disassembled parts recognition model of waste electrical appliance; F is the input features of G_{ω} (F; ωₜ), ωₜ is the weight of G_{ω} (F; ωₜ) with a weight matrix size of 2048×10;
(3) the recognition model of disassembled parts of waste electrical appliances is trained with precision-quantized sparse representation; the recognition model is trained with input training set Xₛ; the recognition model training is completed after processing through F_{θ} (Xₛ; θₜ) and G_{ω} (F; ωₜ); the training total loss function L_{D} for G_{ω} (F; ωₜ) is:

$${L}_{D} = {L}_{c e} + {L}_{q e} + {L}_{b c} ,$$

where L_{qe} is the quantization error loss function; L_{bc} is the distribution loss function; the cross-entropy loss function L_{ce} is calculated as:

$${L}_{c e} = - {\sum }_{j = 1}^{12} {\sum }_{i = 1}^{N} {Y}_{j}^{( i )} log {P}_{j}^{( i )} ,$$

where

$${Y}_{j}^{( i )}$$

is the i-th image data true label of the j-th image category, j=1, 2, . . . , 12, i=1, 2, . . . , N, N is the number of the j-th image category; Pⱼ⁽ⁱ⁾ is the predicted probability of image i belonging to category j; Y is the input image category true label; P is the input image category predicted probability; the unquantized and quantized model parameter losses L_{qe} is calculated as:

$${L}_{qe} = \frac{1}{N} {\sum }_{t = 1}^{N} {( {ω}_{t} - {\hat{ω}}_{t} )}^{2} ,$$

where t=1, 2, . . . , T, T is the total number of training epochs for the disassembled parts recognition model of waste electrical appliance; the weight after quantization \hat{ω}ₜ is calculated as:

$${\hat{ω}}_{t} = round ( \frac{{ω}_{t}}{{Δ}_{ω}} ) \cdot {Δ}_{w} ,$$

where round(·) is the integer rounding operation; the quantization step Δ_{w} is calculated as:

$${Δ}_{ω} = \frac{max ( {ω}_{t} ) - min ( {ω}_{t} )}{{2}^{8} - 1} ,$$

where max(·) denotes taking the maximum value and min(·) denotes taking the minimum value; distribution loss L_{bc} is used to ensure that the output distribution of the quantised model is consistent with the unquantised model; L_{bc} is calculated as:

$${L}_{bc} = E [ ▯ {F}_{θ} ( {X}_{t} ; {θ}_{t} ) ( {O}^{S} - {O}^{H} ) ▯ + 0.01 ▯ {\hat{W}}_{instability}^{t} ▯ ] ,$$

where E[·] denotes the expectation function; [symbol] is the mode of the vector; O^{S} is the output of the layer corresponding to the minimum bit width; O^{H} is the output of the layer corresponding to the maximum bit width; the weighted sparse representation

$${\hat{W}}_{instability}^{t}$$

is calculated as:

$${\hat{W}}_{instability}^{t} = max {{\sum }_{t = 1}}^{300} \frac{1}{{2}^{8} - 1} {‖ {ω}_{t} ‖}_{2}^{2} ▯ H ( {ω}_{t} ) ,$$

where □ is the channel multiplication and the unit step function H(·) is:

$$H ( {ω}_{t} ) = \{ \begin{matrix}0 & {ω}_{t} < 0 \\ 1 & {ω}_{t} \geq 0\end{matrix} ,$$

the parameters θₜ and ωₜ in the disassembled parts recognition model of waste electrical appliances are optimized using the gradient descent algorithm; the parameter updating formulae are:

$${θ}_{t + 1} = {θ}_{t} - 0.01 \frac{\partial {L}_{D}}{\partial {θ}_{t}} ,$$

$${ω}_{t + 1} = {ω}_{t} - 0.01 \frac{\partial {L}_{D}}{\partial {ω}_{t}} ,$$

where θₜ₊₁ is the parameter matrix of G_{ω} (F; ωₜ) at the (t+1)-th iteration of training; θₜ₊₁ is the parameter matrix of F_{θ} (Xₜ; θₜ) at the (t+1)-th iteration of training; ∂ denotes the partial derivatives; at t=300, terminate the training of the recognition model and save the weight parameters of the last training;
(4) the model training is complete, load the weights for the disassembled parts recognition model of waste electrical appliance with precision-quantized sparse representation recognition; use the trained model to recognize 12 categories of disassembled parts in the test set \hat{X}ₛ, and obtain the prediction labels Ŷₛ;

### DESCRIPTION OF THE DRAWINGS

FIG. 1 is the Error distribution of the disassembled parts recognition model for waste electrical appliances based on precision-quantized sparse representation;

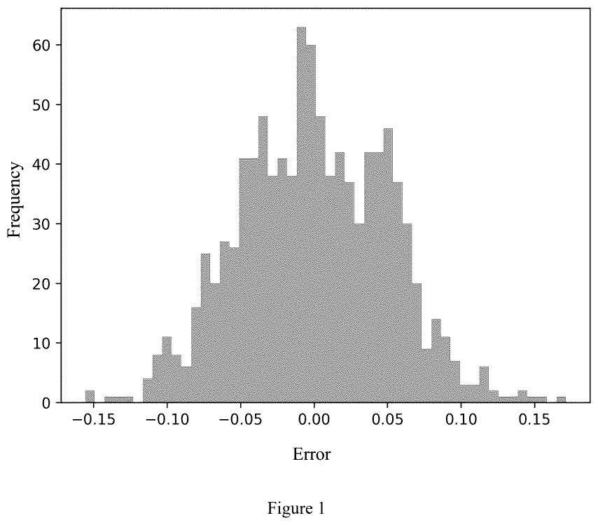

FIG. 2 is the Recognition Flowchart.

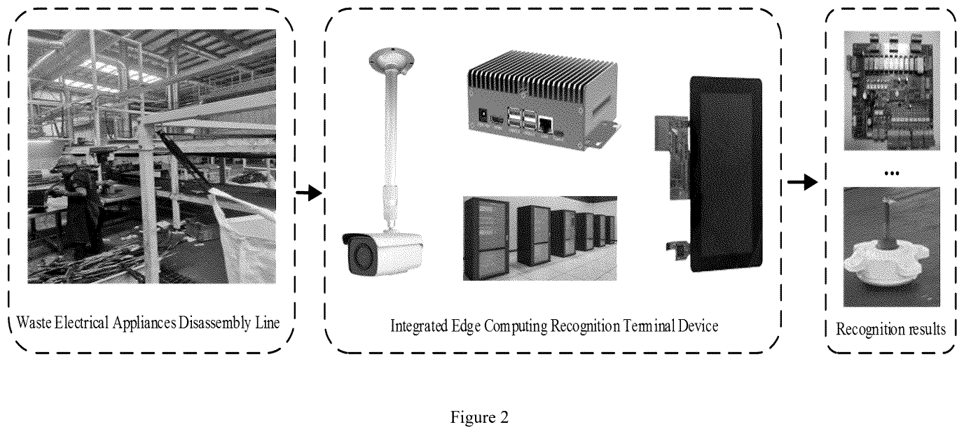

What is claimed is:

1. A precision-quantized sparse representation recognition method for disassembled parts of waste electrical appliance, is implemented via the following device structure:
an integrated edge computing recognition terminal device includes an industrial grade high resolution camera, a gigabit ethernet port, a visual pre-processing module, a neural processing unit, a capacitive touchscreen, and a data server: the industrial grade high resolution camera is used to capture images of disassembled parts on the waste electrical appliance disassembly line; the gigabit ethernet port is used to transmit the captured images to the subsequent computation unit in real time; the visual pre-processing module is used to adjust the brightness, contrast, and sharpness of the captured images; the neural network processor is used to perform image recognition; the capacitive touch screen is used to display the recognition results of the disassembled parts; the data server is used to store the recognition results;
the workflow of the integrated edge computing recognition terminal device is as follows: first, the industrial grade high resolution camera captures and transmits images of the disassembled parts at the edge computing terminal via an ethernet data interface; second, the visual pre-processing module enhances the quality of the captured images, and the neural processing unit outputs the image recognition results; third, the category labels of the disassembled parts are displayed on the capacitive touch screen, and the category labels of the disassembled parts are transformed into a structured form and stored in the data server, with the specific recognition method comprising:
(1) get a dataset containing images of disassembled parts of waste electrical appliance categorized into 12 types: including circuit boards, wires, aluminum, compressors, condensers, transformers, copper tubes, external motors, drains, flame-retardant, waste clutter, and internal fans; normalize the pixel values of each image in the disassembled parts of waste electrical appliance dataset to the range [0,1], to meet recognition model requirements;
the normalized image dataset of disassembled parts of waste electrical appliance is divided into a training set and a test set, with the training set being Xₛ and the test set being \hat{X}ₛ; s is the total number of images with disassembled parts of waste electrical appliance; the total number of \hat{X}ₛ images is 30% of s; the disassembled parts of waste electrical appliances in both \hat{X}ₛ and Xₛ consist of 12 categories;
(2) construct the disassembled parts recognition model of waste electrical appliances with ConvNeXt-Tiny: the model consists of five parts, the first part conv1 consists of a 1×1 convolutional layer, a batch normalization layer, and a GeLU activation function layer, with a channel count of 96; the second part conv2 includes two inverted bottleneck modules, each consisting of a 1×1 depthwise separable convolutional layer, a GeLU activation function layer, and a 1×1 convolutional layer, with a channel count of 96; the third part conv3 contains two inverted bottleneck modules, each consisting of a 1×1 depthwise separable convolutional layer, a GeLU activation function layer, and a 1×1 convolutional layer, with a channel count of 192; the fourth part conv4 is composed of two inverted bottleneck modules, each consisting of a 1×1 depthwise separable convolutional layer, a GeLU activation function layer, and a 1×1 convolutional layer, with a channel count of 384; the fifth part conv5 incorporates two inverted bottleneck modules, each consisting of a 1×1 depthwise separable convolutional layer, a GeLU activation function layer, and a 1×1 convolutional layer, with a channel count of 768; Xₛ is the input for the disassembled parts recognition model of waste electrical appliance with ConvNeXt-T; define F_{θ} (Xₛ; θₜ) as the feature extractor of the disassembled parts recognition model of waste electrical appliance; t is the number of training epochs; θₜ is the learnable parameters of F_{θ} (Xₛ; θₜ) with a parameter matrix size of 512×28×28; G_{ω} (F; ωₜ) is the output of the disassembled parts recognition model of waste electrical appliance; F is the input features of G_{ω} (F; ωₜ), ωₜ is the weight of G_{ω} (F; ωₜ) with a weight matrix size of 2048×10;
(3) the recognition model of disassembled parts of waste electrical appliances is trained with precision-quantized sparse representation; the recognition model is trained with input training set Xₛ; the recognition model training is completed after processing through F_{θ} (Xₛ; θₜ) and G_{ω} (F; ωₜ); the training total loss function L_{D} for G_{ω} (F; ωₜ) is:
$${L}_{D} = {L}_{ce} + {L}_{qe} + {L}_{bc} ,$$
where L_{qe} is the quantization error loss function; L_{bc} is the distribution loss function; the cross-entropy loss function L_{ce} is calculated as:
$${L}_{ce} = - {{\sum }_{j = 1}}^{12} {{\sum }_{i = 1}}^{N} {Y}_{j}^{( i )} log {P}_{j}^{( i )} ,$$
where Yⱼ⁽ⁱ⁾ is the i-th image data true label of the j-th image category, j=1, 2, . . . , 12, i=1, 2, . . . , N, N is the number of the j-th image category;
$${P}_{j}^{( i )}$$
is the predicted probability of image i belonging to category j; Y is the input image category true label; P is the input image category predicted probability; the unquantized and quantized model parameter losses L_{qe} is calculated as:
$${L}_{qe} = \frac{1}{N} {{\sum }_{t = 1}}^{N} {( {ω}_{t} - {\hat{ω}}_{t} )}^{2} ,$$
where t=1, 2, . . . , T, T is the total number of training epochs for the disassembled parts recognition model of waste electrical appliance; the weight after quantization ωₜ is calculated as:
$${\hat{ω}}_{t} = round ( \frac{{ω}_{t}}{{Δ}_{ω}} ) \cdot {Δ}_{w} ,$$
where round(·) is the integer rounding operation; the quantization step Δ_{w} is calculated as:
$${Δ}_{ω} = \frac{max ( {ω}_{t} ) - min ( {ω}_{t} )}{{2}^{8} - 1} ,$$
where max(·) denotes taking the maximum value and min(·) denotes taking the minimum value; distribution loss L_{bc} is used to ensure that the output distribution of the quantised model is consistent with the unquantised model; L_{bc} is calculated as:
$${L}_{bc} = E [ ▯ {F}_{θ} ( {X}_{t} ; {θ}_{t} ) ( {O}^{S} - {O}^{H} ) ▯ + 0.01 ▯ {\hat{W}}_{instability}^{t} ▯ ] ,$$
where E[·] denotes the expectation function; [symbol]
is the mode of the vector; O^{S} is the output of the layer corresponding to the minimum bit width; O^{H} is the output of the layer corresponding to the maximum bit width; the weighted sparse representation Ŵ_{instability}^{t} is calculated as:
$${\hat{W}}_{instability}^{t} = max {{\sum }_{t = 1}}^{300} \frac{1}{{2}^{8} - 1} {‖ {ω}_{t} ‖}_{2}^{2} ▯ H ( {ω}_{t} ) ,$$
where □ is the channel multiplication and the unit step function H(·) is:
$$H ( {ω}_{t} ) = \{ \begin{matrix}0 & {ω}_{t} < 0 \\ 1 & {ω}_{t} \geq 0\end{matrix} ,$$
the parameters θₜ and ωₜ in the disassembled parts recognition model of waste electrical appliances are optimized using the gradient descent algorithm; the parameter updating formulae are:
$${θ}_{t + 1} = {θ}_{t} - 0.01 \frac{\partial {L}_{D}}{\partial {θ}_{t}} ,$$
$${ω}_{t + 1} = {ω}_{t} - 0.01 \frac{\partial {L}_{D}}{\partial {ω}_{t}} ,$$
where ωₜ₊₁ is the parameter matrix of G_{ω} (F; ωₜ) at the (t+1)-th iteration of training; θₜ₊₁ is the parameter matrix of F_{θ} (Xₜ; θₜ) at the (t+1)-th iteration of training; & denotes the partial derivatives; at t=300, terminate the training of the recognition model and save the weight parameters of the last training;
(4) upon completion of model training, load the weights for the disassembled parts recognition model of waste electrical appliance with precision-quantized sparse representation recognition; use the trained model to recognize 12 categories of disassembled parts in the test set \hat{X}ₛ, and obtain the prediction labels Ŷₛ.
